(19) United States
(12) Patent Application Publication
(10) Pub. No.: US 2026/0290794 A1
(43) Pub. Date: Sep. 24, 2026

(54) POSITIVE ELECTRODE COMPOSITE ACTIVE MATERIAL PARTICLE

(71) Applicant: HONDA MOTOR CO., LTD., Tokyo (JP)

(72) Inventors: Yusuke YOSHIZAKI, Tokyo (JP); Hiroto MAEYAMA, Saitama (JP); Noriaki KAMAYA, Saitama (JP)

(21) Appl. No.: 19/568,938

(22) Filed: Mar. 17, 2026

(30) Foreign Application Priority Data
Mar. 21, 2025 (JP) 2025-047276

(51) Int. Cl. H01M 4/36; H01M 4/02; H01M 4/525; H01M 4/62; H01M 10/0562

(52) U.S. Cl. CPC H01M 4/366; H01M 4/525; H01M 4/62; H01M 10/0562; H01M 2004/021; H01M 2300/0068

(57) ABSTRACT

Positive electrode composite active material particles in which at least a part of a surface of positive electrode active material particles containing a lithium-containing oxide is coated with a coating layer, wherein
the coating layer contains a sulfide solid electrolyte, and
a thickness of the coating layer determined by measurement using X-ray photoelectron spectroscopy is less than 110 nm.

### BACKGROUND

### Technical Field

The present invention relates to a positive electrode composite active material particle.

### Related Art

In recent years, research and development on a secondary battery that contributes to improvement of energy efficiency have been conducted. In particular, a lithium ion secondary battery is becoming increasingly important as a power source for an electric vehicle (EV), a hybrid electric vehicle (HEV), or the like.

A positive electrode active material has attracted attention as an important component for determining a capacity of a lithium ion secondary battery, and development thereof has been advanced. In an all-solid-state battery, in order to reduce interface resistance between a positive electrode active material and a solid electrolyte, a technique of coating positive electrode active material particles with the solid electrolyte has been reported (See, for example, JP 2021-163580 A).

### CITATION LIST

### Patent Literature

Patent Literature 1: JP 2021-163580 A

In order to reduce the interface resistance between the positive electrode active material and the solid electrolyte, it is effective to increase the amount of the solid electrolyte coating the positive electrode active material particles with respect to the positive electrode active material particles in order to ensure a contact area.

However, when the amount of the solid electrolyte is excessively increased, the film thickness of the solid electrolyte coating the positive electrode active material particles increases, and there is a problem that a discharge capacity of the battery decreases.

The present invention has been made in order to solve the above problems, and an object of the present invention is to provide positive electrode composite active material particles capable of suppressing a decrease in discharge capacity while reducing interface resistance between positive electrode active material particles and a sulfide solid electrolyte. Consequently, the present invention contributes to improvement of energy efficiency.

### SUMMARY

In order to achieve the above object, the present invention provides the following configurations.

[1] Positive electrode composite active material particles in which at least a part of a surface of positive electrode active material particles containing a lithium-containing oxide is coated with a coating layer, wherein
the coating layer contains a sulfide solid electrolyte, and
a thickness of the coating layer determined by measurement using X-ray photoelectron spectroscopy (XPS) is less than 110 nm.

In the positive electrode composite active material particles according to [1], the thickness of the coating layer containing the sulfide solid electrolyte satisfies a specific numerical range. Therefore, it is possible to suppress a decrease in discharge capacity while reducing interface resistance between the positive electrode active material particles and the sulfide solid electrolyte. Therefore, a battery having an excellent discharge capacity can be obtained, which can contribute to energy saving. That is, it is possible to contribute to improvement of energy efficiency.

[2] The positive electrode composite active material particles according to [1], wherein the thickness of the coating layer determined by measurement using X-ray photoelectron spectroscopy (XPS) is less than 50 nm.

In the positive electrode composite active material particles according to [2], the thickness of the coating layer containing the sulfide solid electrolyte satisfies a specific numerical range. Therefore, it is possible to further reduce interface resistance between the positive electrode active material particles and the sulfide solid electrolyte and to further suppress a decrease in discharge capacity. Therefore, a battery having an excellent discharge capacity can be obtained, which can contribute to energy saving and further improvement of energy efficiency.

[3] The positive electrode composite active material particles according to [1] or [2], wherein a mass ratio of a mass of the coating layer to a total mass of a mass of the positive electrode active material particles and the mass of the coating layer is less than 17.6% by mass.

In the positive electrode composite active material particles according to [3], the mass ratio of the mass of the coating layer to the total mass of the mass of the positive electrode active material particles and the mass of the coating layer satisfies a specific numerical range. Therefore, it is possible to further reduce interface resistance between the positive electrode active material particles and the sulfide solid electrolyte and to further suppress a decrease in discharge capacity. Therefore, a battery having an excellent discharge capacity can be obtained, which can contribute to energy saving and further improvement of energy efficiency.

[4] The positive electrode composite active material particles according to any one of [1] to [3], wherein a coating ratio of the coating layer, which is determined by measurement using X-ray photoelectron spectroscopy (XPS) and is represented by the following formula (1), is 70% or more:

$$( 1 )$$

$$( coating ratio ) ( \% ) = ( abundance ratio of elements derived from the sulfide solid electrolyte ) / ( abundance ratio of elements derived from the sulfide solid electrolyte + abundance ratio of elements derived from the positive electrode active material particles ) \times 100$$

In the positive electrode composite active material particles according to [4], the coating ratio represented by the specific formula satisfies a specific numerical range. Therefore, direct current resistance of a lithium ion secondary battery using the positive electrode composite active material particles can be reduced. Therefore, output characteristics can be further improved, which can contribute to further improvement of energy efficiency.

[5] The positive electrode composite active material particles according to any one of [1] to [4], having an average particle size of 1.0 μm or more and 15.0 μm or less.

In the positive electrode composite active material particles according to [5], the average particle size satisfies a specific numerical range. Therefore, direct current resistance of a lithium ion secondary battery using the positive electrode composite active material particles can be further reduced. Therefore, output characteristics can be further improved, which can contribute to further improvement of energy efficiency.

[6] The positive electrode composite active material particles according to any one of [1] to [5], wherein a product of a specific surface area and an average particle size is 1.5 (m²/g×μm) or more.

In the positive electrode composite active material particles according to [6], the product of the specific surface area and the average particle size (specific surface area (m²/g)×average particle size (μm)) satisfies a specific numerical range. Therefore, a contact area between the positive electrode active material particles and the sulfide solid electrolyte can be ensured, and direct current resistance of a lithium ion secondary battery using the positive electrode composite active material particles can be further reduced. Therefore, output characteristics can be further improved, which can contribute to further improvement of energy efficiency.

[7] The positive electrode composite active material particles according to any one of [1] to [6], wherein the thickness of the coating layer determined by measurement using X-ray photoelectron spectroscopy is an average thickness of the coating layer.

In the positive electrode composite active material particles according to [7], the thickness of the coating layer determined by measurement using X-ray photoelectron spectroscopy is an average thickness of the coating layer. Therefore, accuracy of a calculated value can be further enhanced. The average thickness of the coating layer is considered to more accurately represent the actual thickness of the coating layer.

According to the positive electrode composite active material particles of the present invention, it is possible to suppress a decrease in discharge capacity while reducing interface resistance between positive electrode active material particles and a sulfide solid electrolyte.

### BRIEF DESCRIPTION OF DRAWINGS

FIG. 1 is an example of an XPS depth profile used when a thickness of a coating layer is calculated; and

FIG. 2 is a cross-sectional SEM image of a positive electrode composite active material particle of Example 1.

### DETAILED DESCRIPTION

Hereinafter, a preferred embodiment of the present invention will be described in detail.

### [Positive Electrode Composite Active Material Particles]

In positive electrode composite active material particles of the present embodiment, at least a part of a surface of positive electrode active material particles containing a lithium-containing oxide is coated with a coating layer.

The coating layer contains a sulfide solid electrolyte.

The thickness of the coating layer determined by X-ray photoelectron spectroscopy (XPS) measurement is less than 110 nm.

As long as a function of the present invention is not impaired, the positive electrode composite active material particles may contain components other than a lithium-containing oxide and a sulfide solid electrolyte.

### (Positive Electrode Active Material Particles)

The positive electrode active material particles of the present embodiment contain a lithium-containing oxide. The lithium-containing oxide is preferably a lithium composite oxide. The lithium composite oxide is a transition metal oxide containing lithium, and is an active material that generates a noble potential with respect to lithium metal when a battery is constituted using lithium as a counter electrode. That is, it is important that the lithium-containing oxide is an oxide containing lithium, and the lithium-containing oxide does not particularly depend on a composition or a crystal structure.

The shape of the positive electrode active material particle is preferably a shape having less irregularities from a viewpoint that coating with a sulfide solid electrolyte described later is easy in dry mixing. In particular, a primary particle shape is more preferable than a secondary particle shape which is an aggregate of primary particles.

Specific examples of the positive electrode active material particle include: a layered positive electrode active material particle such as LiCoO₂, LiNiO₂, LiCoₓNi_{y}Mn_{z}O₂ (X>0, Y>0, Z>0, and X+Y+Z=1 are satisfied, for example, LiCo_{1/3}Ni_{1/3}Mn_{1/3}O₂, LiCo_{0.2}Ni_{0.6}Mn_{0.2}O₂, LiCo_{0.1}Ni_{0.7}Mn_{0,2}O₂, or LiCo_{0.1}Ni_{0.8}Mn_{0.1}O₂), LiNi_{X}Mn_{Y}O₂ (X>0, Y>0, and X+Y=1 are satisfied), LiVO₂, or LiCro₂; a spinel type positive electrode active material such as LiMn₂O₄, Li (Ni_{0.25}Mn_{0.75})₂O₄, LiCoMnO₄, or Li₂NiMn₃O₈; and an olivine type positive electrode active material such as LiCoPO₄, LiMnPO₄, or LiFePO₄. Among these, a composite oxide having a layered rock salt type structure containing any element of Ni, Co, and Mn is preferable.

A surface of the positive electrode active material particles is preferably coated with an oxide containing, for example, niobium (Nb), phosphorus (P), or boron (B) (hereinafter, also referred to as “Nb-based oxide”). As a result, when the surface of the positive electrode active material particles is coated with a sulfide solid electrolyte described later, it is possible to suppress deterioration of the positive electrode composite active material particles due to a reaction between the sulfide solid electrolyte and the positive electrode active material particles.

When the surface of the positive electrode active material particles is coated with a Nb-based oxide, a mass ratio between the lithium-containing oxide and the Nb-based oxide (lithium-containing oxide: Nb-based oxide) is preferably, for example, 100:1 to 10:1. When the mass ratio between the lithium-containing oxide and the Nb-based oxide is within the above numerical range, a decrease in discharge capacity and deterioration of the positive electrode composite active material particle can be suppressed in a more balanced manner.

An average particle size of the positive electrode active material particles is, for example, preferably 1.0 μm or more and 15.0 μm or less, more preferably 1.2 μm or more and 12.5 μm or less, still more preferably 2.0 μm or more and 10.5 μm or less, further still more preferably 2.5 μm or more and 7.2 μm or less, further still more preferably 3.0 μm or more and 6.0 μm or less, and particularly preferably 4.0 μm or more and 5.5 μm or less. When the average particle size of the positive electrode active material particles is within the above numerical range, a contact area between the positive electrode active material particles and the sulfide solid electrolyte can be ensured, and an effect of reducing interface resistance is more reliably exhibited.

In the present specification, the “average particle size” means a volume-based 50% particle diameter (median diameter, D50) measured by a laser diffraction particle size distribution measuring apparatus or the like.

### (Sulfide Solid Electrolyte)

The sulfide solid electrolyte usually contains a metal element (M) to be a conducting ion and sulfur(S). Examples of M include Li, Na, K, Mg, and Ca, and Li is used in the present embodiment in which Li ion conductivity is required.

In particular, the sulfide solid electrolyte of the present embodiment preferably contains Li, A (A is at least one selected from the group consisting of P, Si, Ge, Al, and B), and S. A is preferably P (phosphorus). Furthermore, the sulfide solid electrolyte may contain a halogen such as Cl, Br, or I from a viewpoint of improving ion conductivity. In addition, the sulfide solid electrolyte may contain O (oxygen).

Examples of the Li ion conductive sulfide solid electrolyte of the present embodiment include Li₂S—P₂S₅, Li₂S—P₂S₅—LiI, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which m and n are positive numbers, and Z is any of Ge, Zn, and Ga), Li₂S—GeS₂, Li₂S—SiS₂—Li₃PO₄, Li₂S—SiS₂—LiₓMO_{y} (in which x and y are positive numbers, and M is any of P, Si, Ge, B, Al, Ga, and In), and LiᵥP_{w}SₓCl_{y}Br_{z} (V, W, X, y, z>0). It is preferable to use LiᵥP_{w}SₓCl_{y}Br_{z} (V, w, x, y, z>0), and for example, it is more preferable to use Li_{5.4}PS_{4.4}Cl_{0.8}Br_{0.8} from a viewpoint of further enhancing ion conductivity in the coating layer and the positive electrode composite active material particles of the present embodiment and reducing direct current resistance of a lithium ion secondary battery using the positive electrode composite active material particles.

Note that the above description of “Li₂S—P₂S₅” means a sulfide solid electrolyte formed using a raw material composition containing Li₂S and P₂S₅, and the same applies to other descriptions.

When the sulfide solid electrolyte is formed using a raw material composition containing Li₂S and P₂S₅, a ratio of Li₂S to the total of Li₂S and P₂S₅ is, for example, preferably in a range of 70 mol % to 80 mol %, more preferably in a range of 72 mol % to 78 mol %, and still more preferably in a range of 74 mol % to 76 mol %. This is because a sulfide solid electrolyte having an ortho-composition or a composition in the vicinity thereof can be used, and a sulfide solid electrolyte having high chemical stability can be used. Here, the ortho generally refers to an oxoacid having the highest degree of hydration among oxoacids obtained by hydrating the same oxide. In the present embodiment, a crystal composition in which the largest amount of Li₂S is added among sulfides is referred to as an ortho-composition. In the Li₂S—P₂S₅-based composition, Li₃PS₄ corresponds to the ortho-composition. In the case of the Li₂S—P₂S₅-based sulfide solid electrolyte, a ratio between Li₂S and P₂S₅ for obtaining the ortho-composition is Li₂S:P₂S₅=75:25 on a molar basis. Note that the preferable range is also similar when Al₂S₃ or B₂S₃ is used instead of P₂S₅ in the raw material composition. In the Li₂S—Al₂S₃-based composition, Li₃AlS₃ corresponds to the ortho-composition, and in the Li₂S—B₂S₃-based composition, Li₃BS₃ corresponds to the ortho-composition.

When the sulfide solid electrolyte is formed using a raw material composition containing Li₂S and SiS₂, a ratio of Li₂S to the total of Li₂S and SiS₂ is, for example, preferably in a range of 60 mol % to 72 mol %, more preferably in a range of 62 mol % to 70 mol %, and still more preferably in a range of 64 mol % to 68 mol %. This is because a sulfide solid electrolyte having an ortho-composition or a composition in the vicinity thereof can be used, and a sulfide solid electrolyte having high chemical stability can be used. In the Li₂S—SiS₂-based composition, Li₄SiS₄ corresponds to the ortho-composition. In the case of the Li₂S—SiS₂-based sulfide solid electrolyte, a ratio between Li₂S and SiS₂ for obtaining the ortho-composition is Li₂S:SiS₂=66.6:33.3 on a molar basis. Note that the preferable range is also similar when GeS₂ is used instead of SiS₂ in the raw material composition. In the Li₂S—GeS₂-based composition, Li₄GeS₄ corresponds to the ortho-composition.

When the sulfide solid electrolyte is formed using a raw material composition containing LiX (X=Cl, Br, or I), a ratio of LiX is, for example, preferably in a range of 1 mol % to 60 mol %, more preferably in a range of 5 mol % to 50 molo, and still more preferably in a range of 10 mol % to 40 mol %.

In addition, the sulfide solid electrolyte may be sulfide glass or crystallized sulfide glass, or may be a crystalline material obtained by a solid phase method. Note that the sulfide glass can be obtained, for example, by performing mechanical milling (ball milling or the like) on a raw material composition. The crystallized sulfide glass can be obtained, for example, by heat-treating the sulfide glass at a temperature equal to or higher than a crystallization temperature. Li ion conductivity of the sulfide solid electrolyte at room temperature is, for example, preferably 1×10⁻⁴ S/cm or more, and more preferably 1×10⁻³ S/cm or more.

An average particle size of the sulfide solid electrolyte is, for example, preferably 0.1 μm to 5 μm, more preferably 0.3 μm to 3 μm, and still more preferably 0.5 μm to 2 μm. When the average particle size of the sulfide solid electrolyte is within the above numerical range, it is easy to form a coating layer having an appropriate thickness.

When the average particle size of the sulfide solid electrolyte is represented by Dse (nm) and the average particle size of the positive electrode active material particles is represented by Dam (nm), a value of Dse/Dam is preferably 0.01 or more and 1.5 or less, more preferably 0.05 or more and 1.0 or less, and still more preferably 0.1 or more and 0.5 or less.

The average particle size Dse of the sulfide solid electrolyte means a volume-based 50% particle diameter (median diameter, D50) measured by a laser diffraction particle size distribution measuring apparatus or the like.

The coating layer of the present embodiment is characterized by containing the sulfide solid electrolyte described above. The coating layer may contain a conductive auxiliary agent.

As the conductive auxiliary agent, a conventionally known conductive auxiliary agent can be used. Specific examples of the conductive auxiliary agent include acetylene black, natural graphite, and artificial graphite.

The content of the sulfide solid electrolyte with respect to the total mass of the coating layer is, for example, preferably 50% by mass or more, more preferably 70% by mass or more, still more preferably 90% by mass or more, and may be 100% by mass. When the content of the sulfide solid electrolyte with respect to the total mass of the coating layer is the above lower limit value or more, steps in battery manufacturing can be simplified.

The thickness of the coating layer is less than 110 nm, preferably less than 90 nm, more preferably less than 60 nm, and particularly preferably less than 50 nm. When the thickness of the coating layer is less than the above upper limit value, it is possible to reduce interface resistance between the positive electrode active material particles and the sulfide solid electrolyte and to suppress a decrease in discharge capacity.

A lower limit value of the thickness of the coating layer is preferably, for example, 1 nm or more from a viewpoint of ensuring a contact area between the positive electrode active material particles and the sulfide solid electrolyte.

In the present specification, the thickness of the coating layer may be a measured value at one point, or may be an average value measured as follows. That is, the thickness of the coating layer may mean “average thickness”.

In order to determine the thickness of the coating layer, it is common to draw a line in an image with cross-sectional SEM or the like and to measure the length of the line. In this method, the thickness of the coating layer is a value at one point that changes depending on a position where the line is drawn. The number of positions at which lines are drawn may be increased to a plurality of positions, and an arithmetic average value may be obtained.

On the other hand, the thickness of the coating layer can also be determined as an average thickness of the coating layer in a certain region (a region having a diameter of 200 μm which is a spot diameter of XPS in Examples of the present application) using X-ray photoelectron spectroscopy (XPS) as described later. Accuracy of the calculated value of the average thickness of the coating layer is much higher than that of a value obtained by a conventional measurement method using cross-sectional SEM. Therefore, the average thickness of the coating layer is considered to more accurately represent the actual thickness of the coating layer. For this reason, in the present specification, the “thickness of the coating layer” is preferably the “average thickness of the coating layer”.

Note that the accuracy of the calculated value is further enhanced by increasing the number of points to be measured.

Hereinafter, a method for measuring (calculating) the thickness of the coating layer in the present specification will be described.

Powder of the positive electrode composite active material particles is allowed to stand on a carbon tape so as to cover the carbon tape, and an element ratio of the positive electrode composite active material particles in a depth direction is measured using XPS. A depth when an element ratio of an electron orbital S₂p derived from S (sulfur) contained in the sulfide solid electrolyte of the coating layer is half of a maximum value is defined as the thickness of the coating layer.

More specifically, the thickness of the coating layer is determined by the following method.

While a surface of the powder (sample) of the positive electrode composite active material particles allowed to stand on the carbon tape is etched, the element ratio is measured in a sample depth direction using XPS, and a profile (depth profile) of the element ratio with respect to a depth from the sample surface is acquired. Ion etching is performed under the following conditions, and a depth D from the sample surface is determined from an etching rate and an etching time.

### <<Etching Conditions>>

Ar⁺ ion: 3 kV.
Raster size (region to be etched): 2 mm×2 mm
Etching rate: 10.3 nm/min (in terms of SiO₂)

The sample is pressed against the carbon tape and fixed, and the element ratio in the sample depth direction is measured using XPS. XPS measurement conditions are as follows.

### <<Measurement Conditions>>.

Excited X-ray: AlKα_{1,2} ray
Detection angle: 45°
Spot diameter: 200 μm
Measurement element/electron orbital: Lils, O1s, C1s, P2s, S2p, Cl2p, Br3s, Ni2p, Co3p, and Mn3p.
Scan type: slow scan

The thickness of the coating layer can be calculated by the following method.

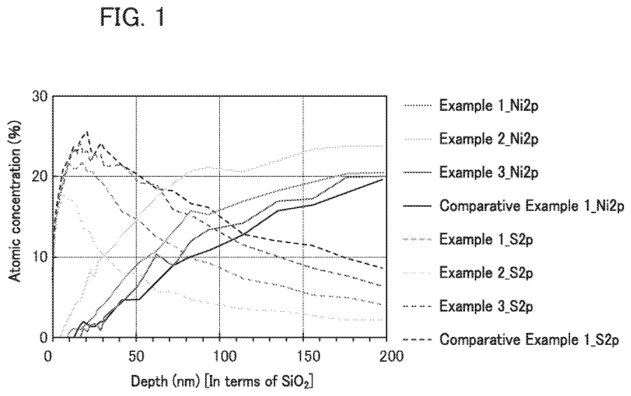

As illustrated in FIG. 1, a plot (XPS depth profile) in which the element ratio is plotted on the vertical axis and the depth D is plotted on the horizontal axis is created. In an XPS depth profile of an electron orbit S2p of sulfur, an element ratio and a depth when the element ratio is maximized are represented by A₀ and D₀, respectively. In a region where the depth is deeper than D₀ (D>D₀), a depth D₁ when the element ratio A is A=½A₀ is defined as the thickness of the coating layer.

Note that FIG. 1 illustrates an electron orbital Ni2p of nickel, which is a signal of the positive electrode active material particle, for reference, together with S2p, which is a signal of the coating layer. FIG. 1 indicates that the element ratio of S2p of the coating layer is higher as a value of the depth D is smaller, and the element ratio of Ni2p of the positive electrode active material particles is higher as a value of the depth D is larger. This means that the coating layer is formed on a surface of the positive electrode active material particles.

A mass ratio of the mass of the coating layer to the total mass of the mass of the positive electrode active material particles and the mass of the coating layer (coating layer/(positive electrode active material particles+coating layer)) is preferably less than 17.6% by mass, more preferably 15% by mass or less, still more preferably 10% by mass or less, and particularly preferably 5% by mass or less. When the coating layer/(positive electrode active material particles+coating layer) is less than the above upper limit value, it is possible to further reduce interface resistance between the positive electrode active material particle and the sulfide solid electrolyte and to further suppress a decrease in discharge Capacity. A lower limit value of the coating layer/(positive electrode active material particles+coating layer) is preferably 1% by mass or more, and more preferably 2.5% by mass or more from a viewpoint of ensuring a contact area between the positive electrode active material particle and the sulfide solid electrolyte.

The coating ratio of the coating layer is preferably 70% or more, more preferably 74% or more, and still more preferably 83% or more. When the coating ratio of the coating layer is the above lower limit value or more, direct current resistance of a lithium ion secondary battery using the positive electrode composite active material particles can be reduced. Therefore, output characteristics can be further improved. An upper limit of the coating ratio of the coating layer is not particularly limited, but is, for example, 99%.

The coating ratio of the coating layer can be calculated by the following formula (1) using XPS.

$$( 1 )$$

$$( coating ratio ) ( \% ) = ( abundance ratio of elements derived from sulfide solid electrolyte ) / ( abundance ratio of elements derived from sulfide solid electrolyte + abundance ratio of elements derived from positive electrode active material particles ) \times 100$$

The “abundance ratio of elements” in the formula (1) is determined by measuring an element ratio on a surface of powder (sample) of the positive electrode composite active material particles by XPS.

In the present embodiment, the “abundance ratio of elements derived from sulfide solid electrolyte” is given by the following formula.
“abundance ratio of elements derived from sulfide solid electrolyte”=“P+S+Cl+Br”

In the present embodiment, the “abundance ratio of elements derived from positive electrode active material particles” is given by the following formula.
“abundance ratio of elements derived from positive electrode active material particle”=“Ni+Co+Mn+O”

Note that when the “abundance ratio of elements” is calculated, Li is not included in the “abundance ratio of elements” described above because Li is contained in both the sulfide solid electrolyte and the positive electrode active material particles.

From the above, when the above formula (1) is represented by element symbols, the following formula (2) is obtained.

$$( coating ratio ) = ( P + S + Cl + Br ) / ( P + S + Cl + Br + Ni + Co + Mn + O ) \times 100 \qquad ( 2 )$$

The coating ratio of the coating layer is determined by the following method.

First, powder (sample) of the positive electrode composite active material particles is pressed against a carbon tape and fixed. Next, an element ratio of a sample surface is measured using XPS. From the measured element ratio, the coating ratio of the coating layer is calculated by the above formula (2). XPS measurement conditions are as follows.

### <<Measurement Conditions>>

Excited X-ray: AlKα_{1,2} ray
Measurement element/electron orbital: O1s, P2s, S2s, Cl2p, Br3s, Ni2p, Co3p, and Mn3p
Scan type: wide scan

A specific surface area of the positive electrode composite active material particles is preferably 0.5 m²/g or more, and more preferably 0.6 m²/g or more. When the specific surface area of the positive electrode composite active material particles is the above lower limit value or more, in a lithium ion secondary battery using the positive electrode composite active material particles, a contact area between the positive electrode active material particles and the sulfide solid electrolyte can be ensured, and direct current resistance of the lithium ion secondary battery using the positive electrode composite active material particles can be reduced. Therefore, output characteristics can be further improved. An upper limit value of the specific surface area of the positive electrode composite active material particles is preferably 1.5 m²/g or less, more preferably 1.1 m²/g or less, still more preferably 0.9 m²/g or less, and particularly preferably 0.8 m²/g or less. When the specific surface area of the positive electrode composite active material particles is the above upper limit or less, handleability of the positive electrode composite active material particles is excellent, and in a lithium ion secondary battery using the positive electrode composite active material particles, interface resistance between the positive electrode composite active material particles and other particles can be further reduced, and a decrease in discharge capacity can be further suppressed.

When the specific surface area of the positive electrode composite active material particle is represented by S (m²/g) and the average particle size of the positive electrode composite active material particles is represented by Dcp (μm), a product of the specific surface area and the average particle size (value of S×Dcp) is preferably 1.5 (m²/g×μm) or more, more preferably 2.2 (m²/g×μm) or more, and still more preferably 2.8 (m²/g×μm) or more. When the product of the specific surface area and the average particle size is the lower limit value or more, in a lithium ion secondary battery using the positive electrode composite active material particles, a contact area between the positive electrode active material particles and the sulfide solid electrolyte can be ensured, and direct current resistance of the lithium ion secondary battery using the positive electrode composite active material particles can be reduced. Therefore, output characteristics can be further improved. An upper limit value of the product of the specific surface area and the average particle size is preferably 6.5 or less, more preferably 4.5 or less, still more preferably 3.5 or less, and particularly preferably 3.1 or less. When the product of the specific surface area and the average particle size is the above upper limit or less, handleability of the positive electrode composite active material particle is excellent, interface resistance between the positive electrode active material particles and the sulfide solid electrolyte can be further reduced, and a decrease in discharge capacity can be further suppressed.

The specific surface area of the positive electrode composite active material particles is determined by performing measurement by a nitrogen adsorption method in accordance with JIS Z8830:2013 and performing calculation by a BET method. Measurement conditions are as follows.

### <<Measurement Conditions>>.

Pretreatment method: Vacuum degassing is performed at 120° C. for eight hours.
Measurement method: An adsorption isotherm with nitrogen is measured using a constant volume method.
Adsorption temperature: 77.35 K
Adsorbate: nitrogen
Adsorbate cross-sectional area: 0.162 nm².
Specific surface area: calculated by BET method

An average particle size of the positive electrode composite active material particles is, for example, preferably 1.0 μm or more and 15.0 μm or less, more preferably 1.2 μm or more and 12.5 μm or less, still more preferably 2.0 μm or more and 10.5 μm or less, further still more preferably 2.5 μm or more and 7.2 μm or less, and particularly preferably 3.0 μm or more and 6.0 μm or less. When the average particle size of the positive electrode composite active material particles is within the above numerical range, direct current resistance of a lithium ion secondary battery using the positive electrode composite active material particles can be reduced.

### [Method for Manufacturing Positive Electrode Composite Active Material Particles]

Next, a method for manufacturing the positive electrode composite active material particles according to the present embodiment will be described.

The method for manufacturing the positive electrode composite active material particles according to the present embodiment includes a mixing step of dry-mixing positive electrode active material particles and a coating material containing a sulfide solid electrolyte.

In this mixing step, the whole or a part of a surface of the positive electrode active material particles is coated with the coating material by shear stress generated by dry mixing. In particular, in a case of a coating material containing a conductive auxiliary agent in addition to the sulfide solid electrolyte, the whole or a part of the surface of the positive electrode active material particles is coated with the coating material uniformly dispersed by dry mixing.

A time for dry mixing depends on the amount and particle size of the sulfide solid electrolyte for coating and a mixing method, but is, for example, preferably 30 minutes, and more preferably 60 minutes in order not to excessively amorphize the sulfide solid electrolyte.

In the mixing step, it is preferable to perform a coating treatment with a high-speed stirring mixer. In the coating treatment with a high-speed stirring mixer, coating of the coating material on the positive electrode active material particles proceeds by shearing between a rotary blade and the particles (the positive electrode active material particles and the coating material containing the sulfide solid electrolyte) inside a treatment tank and collision between the particles. Since only raw materials (the positive electrode active material particles and the coating material) are put into the treatment tank, the high-speed stirring mixer has higher treatment efficiency and can form a denser coating layer than a dry ball mill including raw materials and balls. In addition, since contamination of the raw materials with impurities derived from a material of the balls is small, the high-speed stirring mixer can prevent a decrease in battery capacity of the positive electrode active material particles due to contamination.

Conditions of the coating treatment in the high-speed stirring mixer can be adjusted by the amount of the raw materials to be put into the treatment tank, a peripheral speed of the rotary blade, a time for the coating treatment, and a combination thereof.

According to the positive electrode composite active material particles according to the present embodiment and the method for manufacturing the same, the following effects are exhibited.

In the positive electrode composite active material particles of the present embodiment, at least a part of a surface of the positive electrode active material particles containing a lithium-containing oxide is coated with a coating layer containing a sulfide solid electrolyte to a specific thickness. Therefore, it is possible to suppress a decrease in discharge capacity while reducing interface resistance between the positive electrode active material particles and the sulfide solid electrolyte.

In addition, in the positive electrode composite active material particles of the present embodiment, at least a part of a surface of the positive electrode active material particles containing a lithium-containing oxide is coated with a coating material containing a sulfide solid electrolyte and a conductive auxiliary agent. That is, since electron conductivity can be ensured by presence of the conductive auxiliary agent at an interface between the positive electrode active material particles and the sulfide solid electrolyte, resistance can be reduced. In particular, even in a case of a high energy density battery in which a ratio of the positive electrode active material particles is increased, since an electronic path and a lithium ion path at an interface between the positive electrode active material particles and the coating material can be sufficiently formed, an increase in resistance can be avoided.

In addition, in the positive electrode composite active material particles of the present embodiment, the positive electrode active material particles are formed of a lithium composite oxide. As a result, even when a blending amount of the positive electrode active material particles is high, both excellent electron conductivity and excellent lithium ion conductivity can be achieved, and resistance can be reduced.

In addition, in the positive electrode composite active material particles of the present embodiment, the positive electrode active material particles are formed of a composite oxide having a layered rock salt type structure containing any element of Ni, Co, and Mn. As a result, even when a blending amount of the positive electrode active material particles is high, both better electron conductivity and better lithium ion conductivity can be achieved, and resistance can be further reduced.

The method for manufacturing the positive electrode composite active material particles of the present embodiment includes a mixing step of dry-mixing positive electrode active material particles and a coating material containing a sulfide solid electrolyte. By shear stress generated by dry mixing, positive electrode composite active material particles in which at least a part of a surface thereof is coated with the coating material containing the sulfide solid electrolyte can be manufactured. In particular, in a case of using a coating material containing a conductive auxiliary agent in addition to the sulfide solid electrolyte, a surface of the positive electrode active material particles is coated in advance with the coating material uniformly dispersed by dry mixing, and therefore even when a blending amount of the positive electrode active material particles is high, both excellent electron conductivity and excellent lithium ion conductivity can be achieved, and resistance can be reduced.

### [Solid State Battery]

Next, a positive electrode containing the positive electrode composite active material particles according to the present embodiment and a solid state battery including the positive electrode will be described.

The positive electrode according to the present embodiment is characterized by containing the above-described positive electrode composite active material particles according to the present embodiment. The positive electrode according to the present embodiment contains a conventionally known conductive auxiliary agent, a conventionally known binder, a conventionally known solid electrolyte, and the like in addition to the positive electrode composite active material particles.

The positive electrode containing the positive electrode composite active material particles according to the present embodiment is manufactured by a conventionally known manufacturing method. Specifically, the positive electrode can be manufactured by preparing a positive electrode slurry containing the positive electrode composite active material particles, then applying the positive electrode slurry onto a current collector, and drying the slurry.

In addition, the solid state battery according to the present embodiment is characterized in including a positive electrode containing the above-described positive electrode composite active material particles according to the present embodiment. A conventionally known negative electrode and a conventionally known solid electrolyte can be used, and conventionally known manufacturing methods can also be adopted as manufacturing methods thereof.

The positive electrode according to the present embodiment may contain particles other than the positive electrode composite active material particles. Examples of the other particles include other positive electrode active material particles and other solid electrolyte particles. Examples of the other positive electrode active material particles include positive electrode active material particles having no coating layer. Examples of the other solid electrolyte particles include a solid electrolyte other than the sulfide solid electrolyte contained in the coating layer. As the other solid electrolyte particles, a sulfide solid electrolyte is preferable, and a sulfide solid electrolyte of the same type as the sulfide solid electrolyte contained in the coating layer is more preferable. By using the same type of sulfide solid electrolyte as the sulfide solid electrolyte contained in the coating layer as the other solid electrolyte particles, it is considered that interface resistance hardly occurs between the positive electrode composite active material particles and the solid electrolyte, ion conductivity can be further improved, and direct current resistance in the battery can be further reduced.

According to the above-described positive electrode containing the positive electrode composite active material particles according to the present embodiment and a solid state battery including the positive electrode, similar effects to those of the above-described positive electrode composite active material particles according to the present embodiment are exhibited.

Note that the present invention is not limited to the above embodiment, and modifications and improvements within the scope of achieving the object of the present invention are included in the present invention.

### EXAMPLES

Hereinafter, Examples of the present invention will be described, but the present invention is not limited to Examples below.

### Example 1

### [Preparation of Positive Electrode Composite Active Material Particles]

Ternary positive electrode active material particles and a sulfide solid electrolyte were weighed in a total amount of 144.4 g in a glove box whose dew point was controlled so as to have a mass ratio of 95:5.

Subsequently, the weighed materials were dry-mixed with a high-speed stirring mixer. As mixing conditions, treatment was performed at a peripheral speed of 20 m/s for ten minutes, and then treatment was performed at a peripheral speed of 80 m/s for 50 minutes. A mixed powder after dry mixing was taken out from a treatment tank of the high-speed stirring mixer to obtain positive electrode composite active material particles.

Note that LiCo_{0.1}Ni_{0.7}Mn_{0.2}O₂ (average particle size: 4.0 μm to 5.0 μm) was used for the positive electrode active material particles, and Nb-based oxide coating was performed as follows.

### (Nb-Based Oxide Coating Step)

First, a precursor solution of LiNbO₃ was prepared. A precursor solution of LiNbO₃ was prepared by dissolving LiOC₂H₅ in an ethanol solvent such that 1.0 mol/L ethoxylithium LiOC₂H₅ and 1.0 mol/L pentaethoxyniobium Nb (OC₂H₅)₅ were contained in ethanol.

Coating of the LiNbO₃ precursor solution onto the active material particles was performed using a rolling fluidized coating apparatus. LiCo_{0.1}Ni_{0.7}Mn_{0.2}O₂ (average particle size: 4.0 μm to 5.0 μm) particles, which are lithium transition metal composite oxide particles, were put into a rolling fluidized coating apparatus, and the LiNbO₃ precursor solution was sprayed on the LiCo_{0.1}Ni_{0.7}Mn_{0.2}O₂ particles while the positive electrode active material particles were rolled up with dry air and circulated in the rolling fluidized coating apparatus, thereby obtaining a positive electrode active material powder coated with the precursor of LiNbO₃.

The positive electrode active material powder coated with the precursor of LiNbO₃ was subjected to a heat treatment at 400° C. for two hours in air in an electric furnace to obtain positive electrode active material particles coated with LiNbO₃. In this way, an NCM ternary positive electrode active material coated with Nb was obtained.

The sulfide solid electrolyte was prepared as follows.

For example, as described in the specification of Japanese Patent Application No. 2015-130247, the sulfide solid electrolyte can be prepared by a known method. Specifically, Li₂S, P₂S₅, LiCl, and LiBr were weighed so as to satisfy a composition of Li_{5.4}PS_{4.4}Cl_{0.8}Br_{0.8}, and mixed in an agate mortar for five minutes. Into a container of a planetary ball mill, 2 g of the mixture was put, dehydrated heptane was put thereinto, ZrO₂ balls were further put thereinto, and the container was completely sealed. This container was attached to a planetary ball mill machine, and mechanical milling was performed for 20 hours at a turntable rotation number of 500 rpm. Thereafter, heptane was removed by drying the mixture at 110° C. for one hour to obtain a coarse-grained material of a sulfide solid electrolyte material.

Thereafter, the obtained coarse-grained material was micronized. Dehydrated heptane and dibutyl ether were mixed with the coarse-grained material to adjust the total amount to 10 g and the solid content concentration to 10% by mass. The obtained mixture was put into a container of a planetary ball mill, and ZrO₂ balls were further put thereinto, and the container was completely sealed. This container was attached to a planetary ball mill machine, and mechanical milling was performed for 20 hours at a turntable rotation number of 150 rpm. Thereafter, the mixture was dried to obtain an amorphous sulfide solid electrolyte material (D₅₀=0.7 μm). The amorphous sulfide solid electrolyte material was fired at 200° C. to obtain a sulfide solid electrolyte material as a glass ceramic.

### [Measurement of Thickness of Coating Layer]

The obtained positive electrode composite active material particles (sample) were weighed, and the sample was spread on a carbon tape such that the carbon tape was not exposed, and pressed and fixed. While a surface of the sample was etched, an element ratio was measured in a sample depth direction using XPS, and a profile of the element ratio with respect to a sample depth from the sample surface was acquired (depth profile). Ion etching was performed under the following conditions, and a depth D from the sample surface was determined from an etching rate and an etching time.

### <<Etching Conditions>>

Ar⁺ ion: 3 kV.
Raster size (region to be etched): 2 mm×2 mm
Etching rate: 10.3 nm/min (in terms of SiO₂)

The sample was pressed against a carbon tape and fixed, and an element ratio in a sample depth direction was measured using XPS. XPS measurement conditions were as follows.

### <<Measurement Conditions>>

Excited X-ray: AlKα_{1,2} ray
Detection angle: 45°
Spot diameter: 200 μm
Measurement element: Li, O, C, P, S, Cl, Br, Ni, Co, and Mn.
For an electron orbital corresponding to a measurement element, Lils was selected for Li, O1s was selected for O, Cls was selected for C, P2s was selected for P, S2p was selected for S, Cl2p was selected for Cl, Br3s was selected for Br, Ni2p was selected for Ni, Co3p was selected for Co, and Mn3p was selected for Mn.
Scan type: wide scan.
In scan, peaks were detected for the electron orbitals of Lils, O1s, Cls, P2s, S2p, Cl2p, Br3s, Ni2p, Co3p, and Mn3p, respectively, and peak areas thereof were represented by A_Lils, A_O1s, A_Cls, A_P2s, A_S2p, A_Cl2p, A_Br3s, A_Ni2p, A_Co3p, and A_Mn3p, respectively.
By determining a ratio of a peak area of each electron orbital to a total value of the peak areas of the electron orbitals, element ratios of corresponding measurement elements, M_Li, M_O, M_C, M_P, M_S, M_Cl, M_Br, M_Ni, M_Co, and M_Mn were determined.

For example, an element ratio of S (sulfur) was calculated by M_S=A_S2p/(A_Lils+A_O1s+A_Cls+A_P2s+A_S2p+A_Cl2p+A_Br3s+A_Ni2p+A_Co3p+A_Mn3p), and an element ratio of Ni was calculated by M_Ni=A_Ni2p/(A_Lils+A_O1s+A_Cls+A_P2s+A_S2p+A_Cl2p+A_Br3s+A_Ni2p+A_Co3p+A_Mn3p).

The thickness of the coating layer was calculated by the following method.

First, a plot (XPS depth profile) in which the element ratio was plotted on the vertical axis and the depth D was plotted on the horizontal axis was created. In the XPS depth profile of sulfur, a maximum element ratio was represented by A₀, and a depth at this time was represented by D₀. In a region where the depth was deeper than D₀ (D>D₀), a depth D₁ when the element ratio A satisfied A=½A₀ was defined as the thickness of the coating layer. This thickness of the coating layer means “average thickness”.

### [Measurement of Coating Ratio of Coating Layer]

The obtained positive electrode composite active material particles (sample) were weighed, and the sample was spread on a carbon tape such that the carbon tape was not exposed, and pressed and fixed. Next, an element ratio of a sample surface was measured using XPS. From the measured element ratio, a coating ratio of the coating layer was calculated by the following formula (2).

(coating ratio)=(M_P+M_S+M_Cl+M_Br)/(M_P+M_S+M_Cl+M_Br+M_Ni+M_Co+M_Mn+M_O)×100 (2)

Note that XPS measurement conditions were as follows.

### <<Measurement Conditions>>.

Excited X-ray: AlKα_{1,2} ray.
Measurement element: O, P, S, Cl, Br, Ni, Co, and Mn.
For an electron orbital corresponding to a measurement element, O1s was selected for O, P2s was selected for P, S2p was selected for S, Cl2p was selected for Cl, Br3s was selected for Br, Ni2p was selected for Ni, Co3p was selected for Co, and Mn3p was selected for Mn.
Scan type: wide scan.
In scan, peaks were detected for the electron orbitals of O1s, P2s, S2p, Cl2p, Br3s, Ni2p, Co3p, and Mn3p, respectively, and peak areas thereof were represented by A_O1s, A_P2s, A_S2p, A_Cl2p, A_Br3s, A_Ni2p, A_Co3p, and A_Mn3p, respectively.
By determining a ratio of a peak area of each electron orbital to a total value of the peak areas of the electron orbitals, element ratios of corresponding measurement elements, M_O, M_P, M_S, M_Cl, M_Br, M_Ni, M_Co, and M_Mn were determined. For example, an element ratio of S (sulfur) was calculated by M_S=A_S2p/(A_O1s+A_P2s+A_S2p+A_Cl2p+A_Br3s+A_Ni2p+A_Co3p+A_Mn3p).

### [Measurement of Specific Surface Area]

The obtained positive electrode composite active material particles (sample) were subjected to measurement by a nitrogen adsorption method in accordance with JIS Z8830:2013, and calculation was performed by a BET method to determine a specific surface area of the sample. Measurement conditions were as follows.

### <<Measurement Conditions>>.

Pretreatment method: Vacuum degassing was performed at 120° C. for eight hours.
Measurement method: An adsorption isotherm with nitrogen was measured using a constant volume method.
Adsorption temperature: 77.35 K
Adsorbate: nitrogen
Adsorbate cross-sectional area: 0.162 nm².
Specific surface area: calculated by BET method

### [Cross-Sectional SEM Observation]

The obtained positive electrode composite active material particles were embedded in a resin, and a sample for cross-sectional SEM observation was prepared using Ar ions under an inert atmosphere. The prepared sample was subjected to cross-sectional SEM observation at an accelerating voltage of 2.0 kV using a scanning electron microscope (SEM) “SU8220” manufactured by Hitachi High-Tech Corporation.

### [Preparation of Positive Electrode]

Positive electrode composite active material particles prepared as described above, a sulfide solid electrolyte also prepared as described above, acetylene black as a conductive auxiliary agent, and styrene-butadiene rubber (SBR) as a binder were weighed at a mass ratio of 80:17:2:1 in a glove box with a dew point controlled. As the binder, a solution obtained by previously dissolving SBR in a butyl butyrate solvent at a concentration of 10% by mass was used. Subsequently, the weighed materials were mixed under conditions of 2000 rpm and ten minutes using a rotation and revolution mixer to prepare a positive electrode slurry. For adjusting a viscosity of the positive electrode slurry, a butyl butyrate solvent was appropriately added. Subsequently, the positive electrode slurry was applied onto an aluminum foil using an applicator, and dried on a hot plate at 80° C. for 30 minutes to obtain a positive electrode. A coating amount of the positive electrode mixture was 27.4 mg/cm².

### [Preparation of Negative Electrode]

Metal lithium having a diameter ø of 9.9 mm and a thickness of 1 mm was used.

### [Preparation of Solid State Battery]

The prepared positive electrode was cut using a mold having a diameter ø of 10 mm. Subsequently, 100 mg of powder of a sulfide solid electrolyte prepared as described above was weighed, put into a zirconia ceramic tube having a through-hole having a diameter ¢ of 10 mm, and subjected to powder molding at 200 MPa, thereby obtaining an electrolyte layer. Subsequently, the positive electrode and the negative electrode were put thereinto from above and below, and the mixture was pressed at 1000 MPa to obtain a solid state battery in which the positive electrode, the solid electrolyte layer, and the negative electrode were stacked in this order.

### [Initial Charge-Discharge Test]

The obtained solid state battery was sandwiched between SUS metal pieces from above and below and fastened with bolts to be pressurized at 10 MPa. An initial charge-discharge test was performed using the prepared solid state battery. The initial charge-discharge test was performed at a current value of 0.1 C (0.31 mA/cm²) in an environment of 25° C. The initial charge-discharge test was performed at a charge-discharge voltage of 4.3 V to 2.65 V.

### [⅓ C Discharge Test]

After the initial charge-discharge test, a discharge capacity was acquired at a current value of ⅓ C (1.03 mA/cm²) in an environment of 25° C. The initial charge-discharge test was performed at a charge-discharge voltage of 4.3 V to 2.65 V.

### [DCR Test]

When the discharge capacity at 0.1 C was 180.0 mAh/g or more in the initial charge-discharge test, direct current resistance (DCR) was measured by adjusting SOC to 50% in an environment of 25° C. and then performing discharge at 0.1 C to 5 C for ten seconds.

### Example 2

Positive electrode composite active material particles were obtained in a similar manner to Example 1 except that the ternary positive electrode active material particles and the sulfide solid electrolyte were weighed at a mass ratio of 90:10.

### Example 3

Positive electrode composite active material particles were obtained in a similar manner to Example 1 except that the ternary positive electrode active material particles and the sulfide solid electrolyte were weighed at a mass ratio of 85:15.

### Comparative Example 1

Positive electrode composite active material particles were obtained in a similar manner to Example 1 except that the ternary positive electrode active material particles and the sulfide solid electrolyte were weighed at a mass ratio of 82.4:17.6.

Evaluation results of examples are summarized in Table 1.

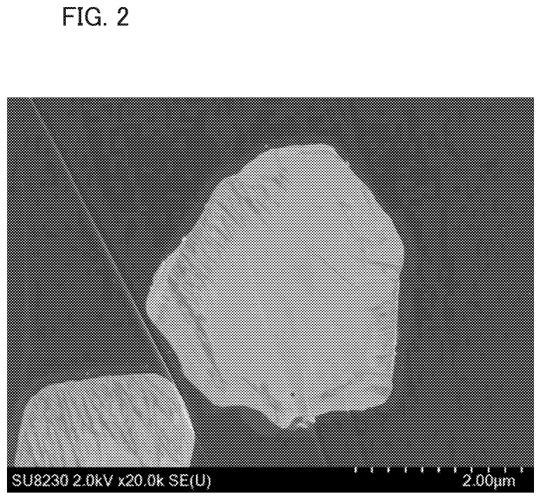

Note that “−” in Comparative Example 1 means that DCR is not calculated. FIG. 2 illustrates a cross-sectional SEM image of a positive electrode composite active material particle of Example 1.

TABLE 1

| | | | | | Comparative |
|---|---|---|---|---|---|
| | | Example 1 | Example 2 | Example 3 | Example 1 |
| Positive | Mass ratio of coating layer | 5.0 | 10.0 | 15.0 | 17.6 |
| electrode | Thickness of coating layer (nm) | 40 | 75 | 105 | 110 |
| composite | Coating ratio of coating layer (%) | 84.5 | 80.6 | 73.8 | 82.1 |
| active | Specific surface area (m²/g) | 0.69 | 0.84 | 1.05 | 1.29 |
| material | Average particle size D50 (μm) | 4.39 | 3.78 | 3.41 | 2.86 |
| particles | Specific surface area (m²/g) × | 3.03 | 3.18 | 3.58 | 3.69 |
| | Average particle size D50 (μm) | | | | |
| Solid state | 0.1 C discharge capacity (mAh/g) | 184.0 | 182.5 | 182.5 | 179.8 |
| battery | ⅓ C discharge capacity (mAh/g) | 171.6 | 173.4 | 173.5 | 161.8 |
| | Ratio of ⅓ C discharge capacity | 93.3 | 95.0 | 95.1 | 90.0 |
| | to 0.1 C discharge capacity (%) | | | | |
| | DCR(Ω/cm²) | 26.77 | 26.43 | 25.51 | — |

From FIG. 2, in the present Example, it was confirmed that at least a part of a surface of the positive electrode active material particles containing the lithium-containing oxide was coated with a coating layer containing a sulfide solid electrolyte.

From Table 1, it was confirmed that Examples 1 to 3 to which the present invention was applied each had a higher discharge capacity than Comparative Example 1 in which the thickness of the coating layer was out of the range of the present invention, and could suppress a decrease in discharge capacity. In addition, it was confirmed that Examples 1 to 3 each had a higher ratio of a ⅓C discharge capacity to a 0.1 C discharge capacity and had a smaller change in value of the discharge capacity due to a current value than Comparative Example 1. Therefore, it is considered that a stable discharge capacity can be obtained regardless of use conditions. Furthermore, in Examples 1 to 3, the larger the ratio of the ⅓ C discharge capacity to the 0.1 C discharge capacity, the lower the direct current resistance (DCR). As a result, it is presumed that in the positive electrode composite active material particles, interface resistance between the positive electrode active material particles and the sulfide solid electrolyte was reduced.

What is claimed is:

1. Positive electrode composite active material particles in which at least a part of a surface of positive electrode active material particles containing a lithium-containing oxide is coated with a coating layer, wherein
the coating layer contains a sulfide solid electrolyte, and
a thickness of the coating layer determined by measurement using X-ray photoelectron spectroscopy is less than 110 nm.

2. The positive electrode composite active material particles according to claim 1, wherein the thickness of the coating layer determined by measurement using X-ray photoelectron spectroscopy is less than 50 nm.

3. The positive electrode composite active material particles according to claim 1, wherein a mass ratio of a mass of the coating layer to a total mass of a mass of the positive electrode active material particles and the mass of the coating layer is less than 17.6% by mass.

4. The positive electrode composite active material particles according to claim 1, wherein a coating ratio of the coating layer, which is determined by measurement using X-ray photoelectron spectroscopy and is represented by the following formula (1), is 70% or more:
(coating ratio)(%)=(abundance ratio of elements derived from the sulfide solid electrolyte)/(abundance ratio of elements derived from the sulfide solid electrolyte+abundance ratio of elements derived from the positive electrode active material particles)×100 (1)

5. The positive electrode composite active material particles according to claim 1, having an average particle size of 1.0 μm or more and 15.0 μm or less.

6. The positive electrode composite active material particles according to claim 1, wherein a product of a specific surface area and an average particle size is 1.5 (m²/g×μm) or more.

7. The positive electrode composite active material particles according to claim 1, wherein the thickness of the coating layer determined by measurement using X-ray photoelectron spectroscopy is an average thickness of the coating layer.
